(19) United States
(12) Patent Application Publication
(10) Pub. No.: US 2017/0163213 A1
(43) Pub. Date: Jun. 8, 2017

(54) Method and Device to Measure Electric Parameters Over Delimited Areas of a Photovoltaic Module

(71) Applicant: Brookhaven Science Associates, LLC, Upton, NY (US)

(72) Inventors: Alessandra Colli, Manorville, NY (US); Klaus Attenkofer, Riverhead, NY (US)

(21) Appl. No.: 15/321,841

(22) PCT Filed: Jun. 30, 2015
(86) PCT No.: PCT/US2015/038516

§ 371 Date: Dec. 23, 2016

Related U.S. Application Data
(60) Provisional application No. 62/019,154, filed on Jun. 30, 2014.

(51) Int. Cl. H02S 50/15

(52) U.S. Cl. CPC H02S 50/15

(57) ABSTRACT

Embodiments of the disclosure relate generally to methods and apparatuses for testing solar cells, and more particularly, to methods and apparatuses for field testing solar cells. The apparatus for testing solar photovoltaic modifies includes a plurality of individual light diffuser wave guides, coupling lenses coupled with the plurality of individual light diffuser wave guides, LED light simulator for providing light through the plurality of individual light diffuser wave guides, air guidance system for providing conditioned air from an air conditioning unit, an air diffuser for diffusing the conditioned air to a surface of the solar photovoltaic modules, and an electronic control circuit for controlling the apparatus.

This application claims the benefit under 35 U.S.C. 119(e) of U.S. Provisional Application No. 62/019,154 filed on Jun. 30, 2014, the disclosure of which is incorporated herein in its entirety.

This invention was made with Government support under contract numbers DE-ACO2-98CH10886 and DE-SC0012704 awarded by the U.S. Department of Energy. The Government has certain rights in the invention.

### FIELD OF THE INVENTION

This disclosure relates generally to methods and apparatuses for testing solar cells, and more particularly, to methods and apparatuses for field testing solar cells.

### BACKGROUND

To develop an alternative energy economy in which solar energy based on photovoltaic (PV) devises plays a major role, risks of system failures at all system levels have to be understood. Because the devices are used outdoors, deterioration occurs due to interactions with the surrounding environment and elements such as irradiance, temperature, humidity, as well as the exposure to the effects of different chemical substances originating from the environment itself or from different human-made activities. Additionally, the use of PV modules within arrays requires them to withstand system voltages of 600-1000 Vdc, or even 1500 Vdc in the most advanced cases, with the risk to undergo a degradation process with shunting and corrosive characteristics originating from the high voltage stress and the presence of leakage currents, if not properly protected. One issue of particular interest, especially in utility-level high voltage systems is the potential induced degradation (PID). The impact of voltage-biased humidity exposure of solar panels on long term stability has been known for a while, yet today, many aspects of this phenomenon still remain unclear.

Therefore, there is a need for an apparatus and method for clarifying the physical processes happening within a PV module and detecting the responsible elements in the degradation of cells.

### SUMMARY

Described herein are approaches to provide a homogeneous light to solar photovoltaic modules in working conditions (field) with modulation capability over the entire module (global) or identified areas (cell, portion of the cell).

In an embodiment, and apparatus is provided which includes:
a) Diffuser optics with waveguide/coupling lens.
b) Control light, temperature, and humidity conditions in operating environment.
c) Integrated modular test setup which combines light source, electronic control circuit, and air conditioning unit with air diffuser and air guidance system.

The modular design allows cost efficient adjustment of the tester to various panel designs.

Embodiments also include methods to detect the signal of a specific portion of solar cell, an individual solar cell, or a portion of the module within the photovoltaic module in working conditions. The method includes:
a) Characterization of a system response caused by sinusoidal or pulsed light excitation under load conditions. Three electrical parameters—cell capacity, the shunt resistivity and the serial resistivity—can be determined under working conditions in the field. The value and the relative variation of these values over time will allow a precise estimation of the remaining lifetime of the solar panel.
b) Measure local electric characteristics of a photovoltaic module in working conditions—for example over spots of 15.6 mm×15.6 mm. The characterization of the local response of a cell may mainly benefit the fault analysis.
c) Potential (voltage) adjustment to the module position and conditions within a string. This will result in a basic understanding of potential induced degradation (PID) effects and a rational approach to minimize the damage.

### BRIEF DESCRIPTION OF THE DRAWINGS

FIG. 1A is an equivalent circuit of an individual cell, according to an embodiment.

FIG. 2 is the voltage response of a single solar cell stimulated by a pulsed LED source (power: 2 W, wavelength: 530 nm) according to an embodiment. The plot shows the voltage of the cell as a response to a light pulse which is trigger by a sine like signal.

FIG. 3 is a single logarithmic plot a linear fit of the capacitor discharge of the single solar cell of FIG. 2.

FIG. 4 is a schematic view of a solar panel tester according to an embodiment

FIG. 5 is a model of a solar simulator according to an embodiment.

FIG. 6 is a model drawing of a light unit assembly according to an embodiment (left side), showing an array of 10×10 light diffuser units with integrated light controller and temperature controller. An individual light diffuser wave guide with concave coupling lens is shown on the right.

FIG. 7 is the bottom view of an embodiment of the light units of FIG. 6.

### DETAILED DESCRIPTION

This disclosure provides embodiments of apparatuses that analyze the physical processes occurring within a PV module and detect the responsible elements in the degradation of cells. This may be performed by scanning or imaging techniques which closes the gap between the basic material physics and the engineering of the outdoor operating PV system.

Visualizing and quantitatively describing the physical processes that result in the degradation of solar cells under field conditions may optimize the installation guidelines of PV plant facilities and therefore directly reduce facility costs by increasing the lifetime of the facility. Furthermore, visualizing and quantitatively describing the physical processes may predict the lifetime and therefore increase the commercial value of existing facilities due to risk minimization. However, the wide variety of degradation pathways and their complex dependency on facility parameters, like grounding scheme, plant design, operation voltage, or general plant design makes it difficult to rationally evaluate the importance and risk impact of individual degradation processes.

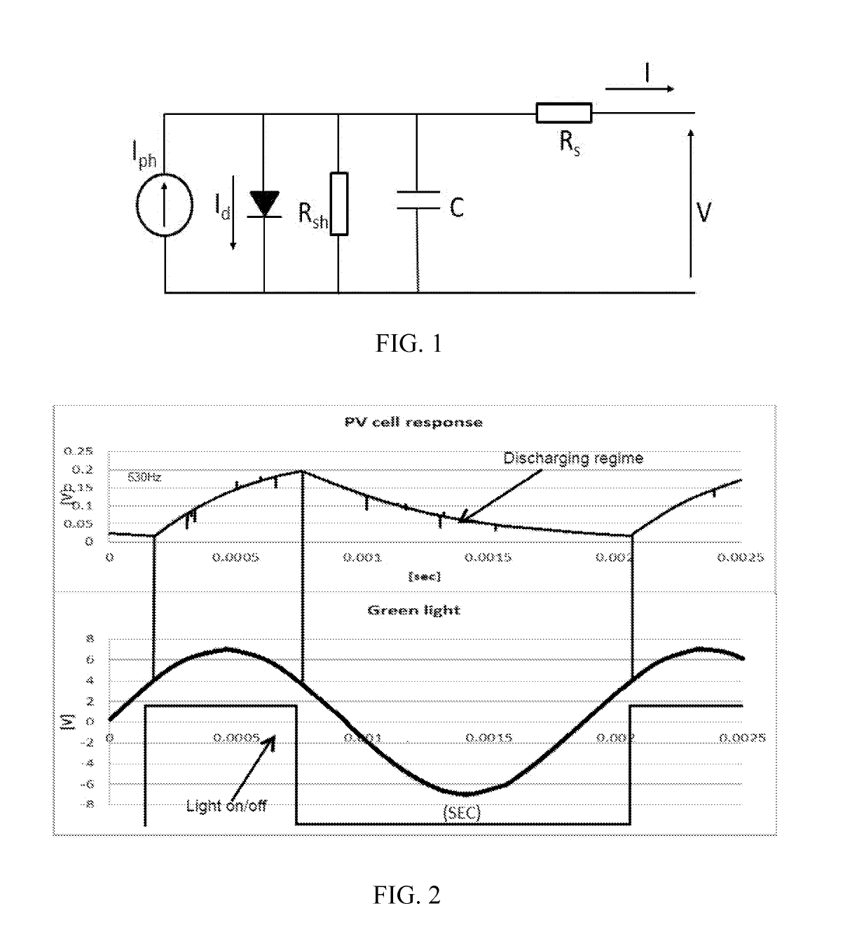

Embodied herein are embodiments of test utilities which allows for periodically measuring the degradation status of each individual cell or portion of cell in a working plant environment to gain a statistical relevant dataset which facilitates correlating degradation with facility parameters without interference of the plant operation. The metric for degradation is the temporal development of the cell capacitance, C, mainly determined by the dopant concentration in the cell, the shunt resistance, Rₛₕ, mainly caused by growth of metallic particles trough out the active area, and the series resistance, Rₛ, determined by contacts and interconnection degradation. A simplified schematic of an equivalent circuit of an individual cell is shown in FIG. 1. Voltage V and current I are determined by the working point of the system according to the IV-curve of the panel. The capacitance C may be disaggregated in different subparts as needed; the capacitance of a solar cell has actually three different contributions: the junction capacitance, the diffusion capacitance, and the transient carrier capacitance.

Recording the temporal degradation behavior of the individual cell instead of the full panel or string may allow the development of unprecedented degradation models which not only increase the sensitivity and reliability of lifetime prognosis but implement macroscopic mobility and trapping models which can be tested with x-ray and electron imaging and scattering techniques. This may help to develop remedies on the cell, panel and system design level which minimizes these degradation effects.

To measure the individual cell behavior within the panel network the cell under investigation (CUI) is illuminated with modulated light whereas the rest of the panel is illuminated with a constant light simulating sun illumination. The continuous illumination of the remaining cells combined with an external dynamic load allows to modify the electric, e.g. the voltage V and current I of the CUI, and its thermal conditions emulating the various working conditions.

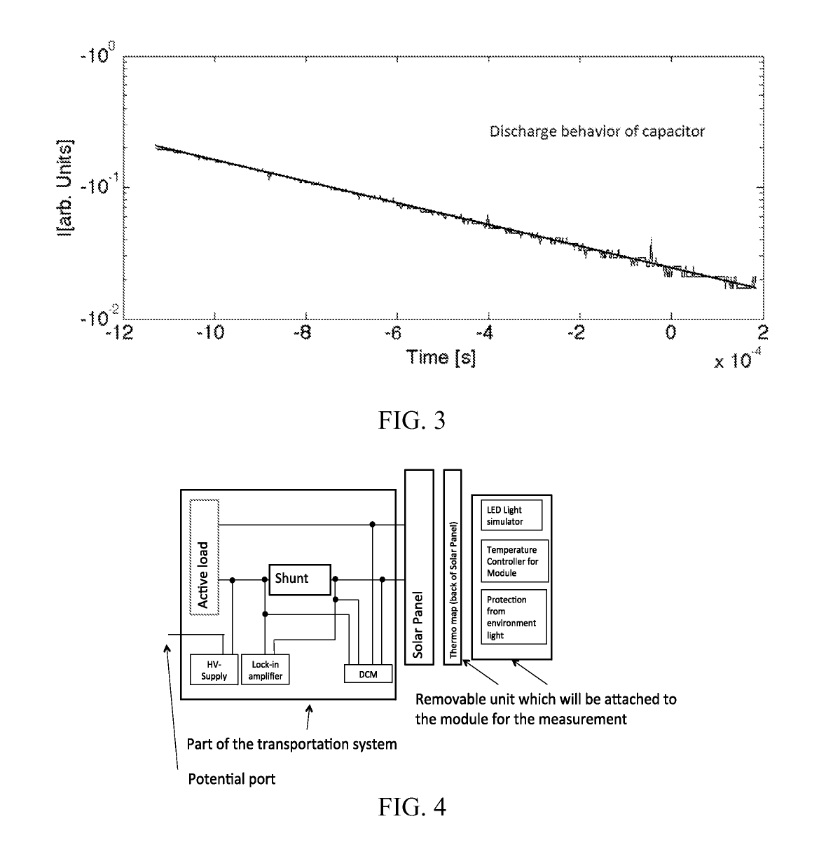

The modulated light on the CUI provides a stimulus to create a unique signal which can be correlated with the cell parameters C, Rₛₕ, and Rₛ of the CUI. In the case of pulsed modulation, the on-phase probes the charging, the off-phase the discharging behavior of the CUI. In an embodiment, the response of an individual cell stimulated with a pulsed LED source with 530 Hz repetition rate is shown in FIG. 2. The discharging cycle shows a linear behavior in a logarithmic plot (FIG. 3), indicating an exponential correlation between the measured voltage and time as expected for the discharge behavior of capacitors.

In an open circuit having a high impedance input of the voltage probe, the discharge resistor is the shunt resistor Rₛₕ. However, for the load on the cell, there is a network of three resistors forming a voltage divider which can be replaced with an equivalent single resistor. The time evolution of the discharge current is described by

$$I ( t ) = \frac{{V}_{0}}{R} {e}^{- \frac{t}{RC}} .$$

A set of measurements can be performed by measuring the discharge behavior at multiple points of the IV-curve allowing determining the shunt and discharge resistances independently.

In a similar way one can use a light modulation which is described by a sine-wave. The resulting current I(t) and voltage V(t) on the cell will show a phase shift

$$θ = \frac{1}{tan ( \frac{{R}_{Sh}}{ω C} )}$$

allowing to determine the shunt resistance Rₛₕ and the cell capacity independently.

The embodiments of the invention may provide an equivalent circuitry for an individual cell which is connected to the other cells and fully mounted in a panel. The starting point may be the model shown in FIG. 1; additional features like leakage currents and parasitic capacities may be implemented depending on the sensitivity (determined with the simulation) and complexity of the analysis. Simulation software (SPICE, SIMetrix, or Matlab) which allows to integrate local current sources may be used to calculate the DC (IV curve) and AC behavior (phase shift and discharge behavior) of the system. AC modulation may be simulated. As input variables it is possible to use known cell parameters; a systematic change of the input parameters may prove a “sensitivity” matrix allowing to extract the required statistical and systematic data quality. The analysis of these data and understanding the sensitivity of the measurement may provide guide lines to optimize the measurement process.

Embodiments encompass a panel test tool that may be easily usable in the field, integrates a temperature and humidity control unit, and a modular sun light simulator which allows global or local continuous or/and modulated light excitation of the panel. The achievable spatial resolution of about 15-20 mm and its modular building concept allows optimizing the system to all commercially important solar panel designs inclusive high capacitive thin film systems.

A layout of the three individual building blocks according to an embodiment is shown in FIG. 4. The measurement electronics, may include all DC and AC measurement electronics, the active load allowing to vary the working point of the panel, and a high voltage supply which permits to move the potential of the panel in respect to ground during the measurement. This first block is part of the transportation system which may also hosts a power generator, an air conditioning unit, and a hydraulic arm which may move the solar simulator unit in place.

The second part is a thermo blanket which may be loosely mounted on the backside of the solar panel; the blanket is connected to the air conditioning unit and may act as an air diffuser. Additionally it may minimize the effects of scattered light penetrating the back support of the panel.

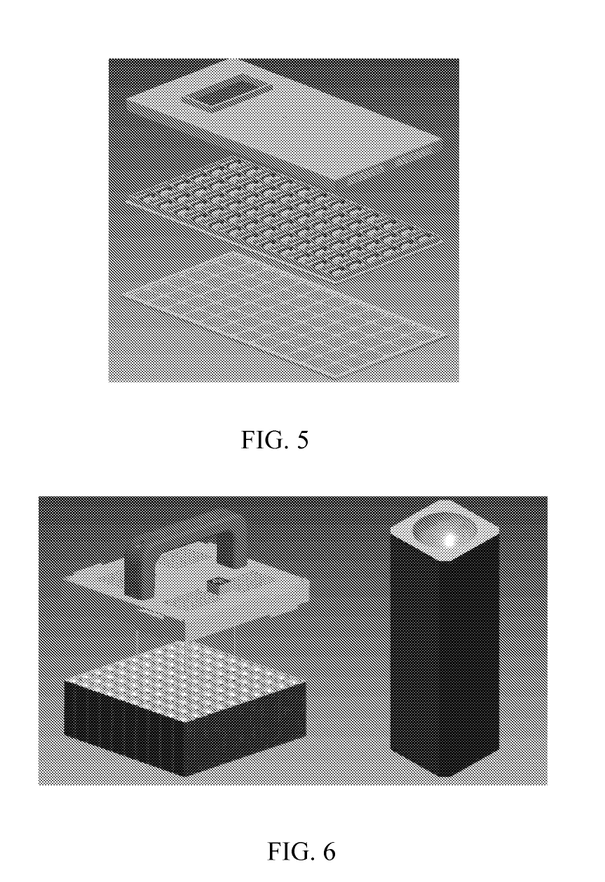

The third block is the light simulator, also shown in FIG. 5, according to an embodiment. The modular system may built out of individual light units and a main-frame which hosts the individual light units, seals to the solar panel and provides the air distribution system on the top side of the panel.

The light units, shown in FIG. 6, are matching with the individual cell of a panel and may be built using any number of individual multi-color LED sources with integrated light diffuser optics. In an embodiment, from and array 10×10 LED sources are used. Each of the light diffusers may be a plastic molded optical wave guide with an integrated concave coupling lens. Using multiple reflections the light originated from the LED-point source may be not only homogeneously distributed over at least a 156×156 mm² area (typical crystalline silicon cell) but also the angle between the individual ray and the cell entrance window may be randomized. The corners of the wave guides may be chamfered forming in the light unit assembly channel to distribute the air of the air conditioning unit or hosting the temperature sensors.

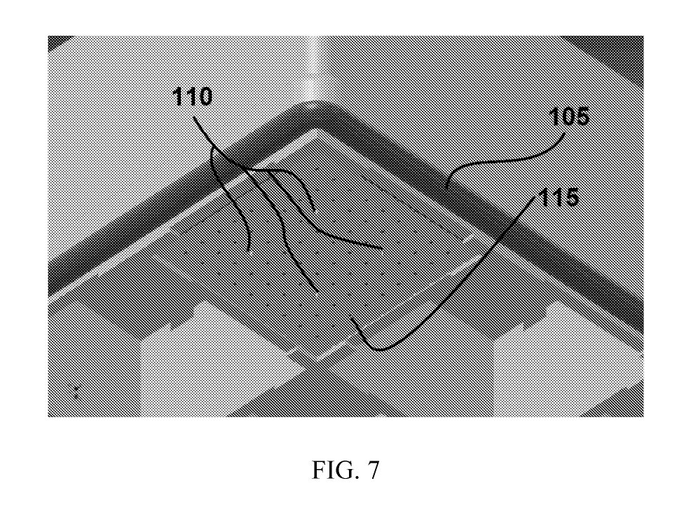

FIG. 7 is the bottom view of an embodiment of the light units of FIG. 6, and includes a seal 105 for air and light, temperature sensors 110, and air diffuser holes 115 for the incoming temperature-controlled air flow from the air conditioning unit.

All control electronics of the light unit may be integrated into the light unit itself allowing a very flexible modular building concept; the digital level may host the programmable controller of all LED sources using high frequency pulse width modulation (PWM), the thermal controller allowing increased or decreased air flow, and the communication bus. A single field programmable gate array (FPGA) may provide IO's and computational power. Filtering and all analog processing of the controls signals may be performed on a second board layer.

Conventional LED sources, similar to T3 LEDs, may be used. These sources may integrate 3 LEDs with 440 nm, 570 nm, and 630 nm emission and provide a total light emission of 2 W per unit. Additional fluorescence materials build into the diode broaden the spectrum, making a good match to the optical part of the sun light spectrum. IR diodes may also be integrated so that the full daylight spectrum can be reproduced. Tests with commercially available LED light bulbs show that about 50-55 diodes may be required to provide the necessary illumination; which means that each diode can be run with only 55% of its rated light output.

The use of LEDs have multiple advantages: their low power consumption making the mobile usage feasible, small source size allowing a simplified and small light distribution system, and a simple and robust handling.

The LED's may be run in two different modes: small modulation amplitude on a large DC light output of a group of LED's and full modulation amplitude without DC light output of a single LED. The electronics and controls system may allow both modes so that specific tests like increased degradation at edges of the cell or the full modules, expected for PID, can be fast tested using specific test programs.

The description has not attempted to exhaustively enumerate all possible variations. The alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. Patents, and U.S. Patent Application Publications cited throughout this specification are incorporated by reference as if fully set forth in this specification.

1. An apparatus for testing solar photovoltaic modules, comprising:
a plurality of individual light diffuser wave guides;
coupling lenses coupled with the plurality of individual light diffuser wave guides;
LED light simulator for providing light through the plurality of individual light diffuser wave guides;
air guidance system for providing conditioned air from an air conditioning unit;
an air diffuser for diffusing the conditioned air to a surface of the solar photovoltaic modules; and
an electronic control circuit for controlling the apparatus, wherein the apparatus is portable and can be used to test solar photovoltaic modules while said photovoltaic modules are in use in a photovoltaic plant facility.

2. An apparatus for providing a homogeneous light to solar photovoltaic modules in working conditions, the apparatus comprising:
a plurality of individual light diffuser wave guides;
coupling lenses coupled with the plurality of individual light diffuser wave guides;
means to control light, temperature, and humidity conditions in an operating environment; and
integrated modular test setup which combines a light source, electronic control circuit, and an air conditioning unit with air diffuser and air guidance system, wherein the apparatus is portable and can be used to test solar photovoltaic modules while said photovoltaic modules are in use in a photovoltaic plant facility.

3. A method for detecting a signal, in working conditions, of a specific portion of solar cell, an individual solar cell, or a portion of a module within a photovoltaic module, the method comprising:
characterization of a system response caused by sinusoidal or pulsed light excitation under load conditions in a photovoltaic plant facility, while electrical parameters are determined under working condition;
measurement of local electric characteristics of a photovoltaic module in working conditions; and
potential adjustment to the module position and conditions within a string.

4. The method of claim 3, wherein the electrical parameters comprise cell capacity, shunt resistivity, serial resistivity, or a combination thereof.

5. The method of claim 4, wherein the electrical parameters determined under working condition and a relative variation of the parameters over time allow for a precise estimation of a remaining lifetime of the photovoltaic module.

6. The method of claim 6, further comprising estimating potential induced degradation (PID).
